(19) United States
(12) Patent Application Publication
(10) Pub. No.: US 2019/0063108 A1
(43) Pub. Date: Feb. 28, 2019

(54) PADLOCK

(71) Applicant: Jae Keun JUNG, Seoul (KR)

(72) Inventor: Jae Keun JUNG, Seoul (KR)

(21) Appl. No.: 15/953,242

(22) Filed: Apr. 13, 2018

(30) Foreign Application Priority Data
Aug. 31, 2017 (KR) 10-2017-0110861
Nov. 1, 2017 (KR) 10-2017-0144875
Feb. 13, 2018 (KR) 10-2018-0017522

(51) Int. Cl. E05B 17/10; E05B 67/02; E05B 67/22; F21V 23/02; F21V 23/06; F21V 23/04; F21K 2/06

(52) U.S. Cl. CPC E05B 17/10; E05B 67/02; E05B 67/22; F21Y 2115/10; F21V 23/06; F21V 23/04; F21K 2/06; F21V 23/02

(57) ABSTRACT

Disclosed is an improved padlock. The padlock includes a padlock body; a shackle coupled to the padlock body and allowing the padlock to be in an unlocked state or locked state; and a light emitting unit coupled to the padlock body and operating in the locked state of the padlock. Thus, when couples use the padlock, for example, for representing a declaration of their love or for celebrating a special day, memorable illumination can be provided.

### CROSS-REFERENCE TO RELATED APPLICATION

This application is based on and claims priority from Korean Patent Applications Nos. 10-2017-0110861 filed on Aug. 31, 2017, 10-2017-0144875 filed on Nov. 1, 2017 and 10-2018-0017522 filed on Feb. 13, 2018 in the Korean Intellectual Property Office, the disclosure of which is incorporated herein in its entirety by reference.

### TECHNICAL FIELD

The present invention relates to a padlock, the padlock being configured such that a light emitting element is provided in a body of the padlock, whereby when the padlock is locked, the light emitting element is lit.

### BACKGROUND ART

Unless otherwise indicated in this specification, the descriptions set forth herein are not meant to be related art to the claims of this application, and are not to be admitted as related art.

A padlock is a lock that can be used to secure objects by an opening and closing operation.

In general, the padlock consists of two parts: a semi-elliptical shackle and a padlock body. When the key is inserted to open the padlock, in a state where one leg of the shackle remains connected to the padlock body, the other leg is separated from the padlock body to open the padlock.

Recently, the padlock has been used beyond traditional use. For example, couples hang padlocks to public fixtures such as the fence of the Pont des Arts Bridge in Paris which crosses the River Seine, or the fence of the roof terrace outside the N Seoul Tower located on Namsan Mountain in Seoul, etc. After the padlocks are locked, the keys are thrown away into a nearby river or lake thus representing the couple's declaration of their love.

As a technique for using the padlock for various purposes, Korean Patent No. 10-1587953, entitled ‘padlock’, disclosed a padlock provided with a lamp.

### DISCLOSURE

### Technical Problem

Accordingly, an object of the present invention is to provide an improved padlock, in which the padlock has an improved structure to light a light emitting element provided in the padlock when couples use the padlock, for example, for representing a declaration of their love or for celebrating a special day.

Furthermore, it is obvious that the present invention is not limited to the above-described object, and another object may be derived from the following description.

### Technical Solution

In order to achieve the above object, according to one aspect of the present invention, there is provided a padlock including: a padlock body; a shackle coupled to the padlock body and allowing the padlock to be in an unlocked state or locked state; and a light emitting unit coupled to the padlock body and operating in the locked state of the padlock.

### Advantageous Effects

According to the present invention having the above-described characteristics, the improved padlock has various structures to light the light emitting element when couples use the padlock, for example, for representing a declaration of their love or for celebrating a special day, thereby providing memorable illumination.

The effects of the present invention are not limited to the effects mentioned above, and other effects not mentioned can be clearly understood by those skilled in the art from the descriptions in the appended claims.

### DESCRIPTION OF DRAWINGS

FIG. 1 a perspective view showing an improved padlock.

FIG. 2 is a front and side exploded view schematically showing a structure of the improved padlock according to a first embodiment of a lighting portion.

FIG. 3 is a front cross-sectional view showing a padlock body according to FIG. 2.

FIG. 4 is a cross-sectional view showing front and side interior structures of the padlock according to FIG. 2.

FIG. 5 is a cross-sectional view schematically showing a front interior structure of an improved padlock according to a second embodiment of a lighting portion.

FIG. 6 is a cross-sectional view schematically showing a front interior structure of an improved padlock according to a third embodiment of a lighting portion.

FIG. 7 is a cross-sectional view schematically showing front and side interior structures of an improved padlock according to a fourth embodiment of a lighting portion.

FIG. 8 is a cross-sectional view schematically showing a front interior structure of an improved padlock according to a fifth embodiment of a lighting portion.

FIG. 9 is a cross-sectional view schematically showing a front interior structure of an improved padlock according to a sixth embodiment of a lighting portion.

FIG. 10 is a front and side exploded view schematically showing a structure of an improved padlock according to a seventh embodiment of a lighting portion.

FIG. 11 is a front cross-sectional view showing a padlock body according to FIG. 10.

FIG. 12 is a cross-sectional view showing front and side internal structures of the padlock according to FIG. 10.

FIG. 13 is a front cross-sectional view showing the padlock body including a second elastic bar and a light emitting unit according to FIG. 10.

FIG. 14 is a cross-sectional view showing front and side internal structures of the padlock including the second elastic bar and the light emitting unit according to FIG. 10.

FIG. 15 is a cross-sectional view schematically showing a front interior structure of an improved padlock according to an eighth embodiment of a lighting portion.

FIG. 16 is a cross-sectional view schematically showing a front interior structure of an improved padlock according to a ninth embodiment of a lighting portion.

FIG. 17 is a cross-sectional view schematically showing front and side interior structures of an improved padlock according to a tenth embodiment of a lighting portion.

FIG. 18 is a cross-sectional view schematically showing a front interior structure of an improved padlock according to an eleventh embodiment of a lighting portion.

FIG. 19 is a cross-sectional view schematically showing a front interior structure of an improved padlock according to a twelfth embodiment of a lighting portion.

### BEST MODE

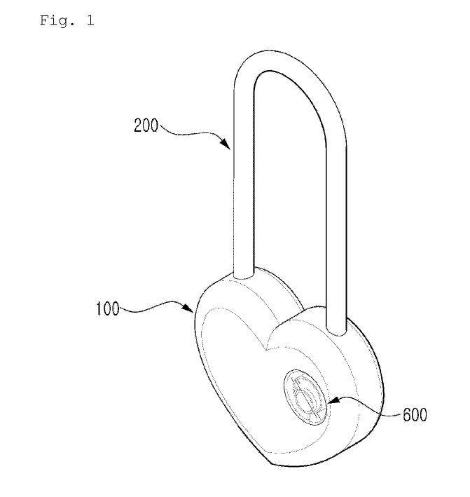

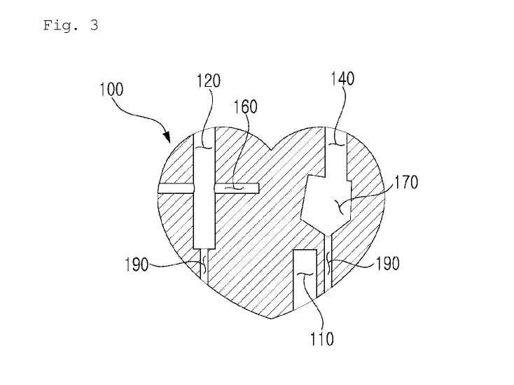

Referring to FIGS. 1 to 4, an improved padlock includes: a padlock body 100 provided with first and second insertion holes 120 and 140 formed vertically and a fixing hole 160 formed horizontally and communicating with the first insertion hole 120; a bent round bar-shaped shackle 200 configured such that a first leg thereof, which is provided with first and second locking grooves 220 and 240 formed to be vertically distanced from each other, is accommodated in the first insertion hole 120, and a second leg thereof is distanced from the padlock body 100 in an unlocked state of the padlock and is inserted into the padlock body 100 through the second insertion hole 140 in a locked state of the padlock; a first elastic body 300 accommodated in the first insertion hole 120 to be in contact with the first leg of the shackle 200; a second elastic body 400 accommodated in the fixing hole 160; a fixing pin 500 configured such that a first side thereof is inserted into the fixing hole 160 to be in contact with the second elastic body 400, and a second side thereof is located in the first locking groove 220 in the unlocked state of the padlock and is located in the second locking groove 240 in the locked state of the padlock; a light emitting unit 600 coupled to the padlock body 100 and operating in the locked state of the padlock.

### MODE FOR INVENTION

Hereinafter, configurations, operations, and effects of a padlock according to a preferred embodiment will be described with reference to the accompanying drawings. For reference, in the following drawings, each component is omitted or schematically shown for convenience and clarity, and the size of each component does not reflect the actual size. The same reference numerals are used throughout the different drawings to designate the same or similar components, and the reference numerals for the same configuration in the individual drawings are omitted.

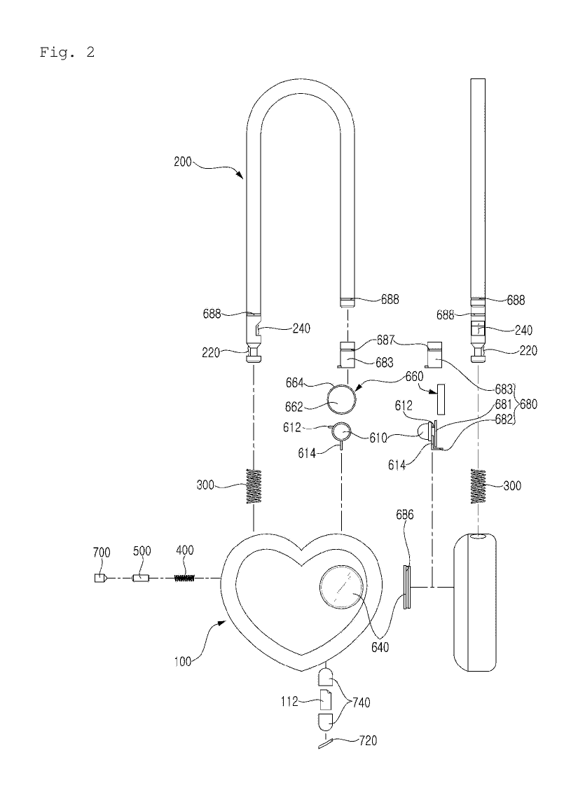

Referring to FIGS. 2 to 4, a padlock body 100, which is a part where a shackle 200 is inserted and withdrawn into and from an upper portion thereof, is configured such that a first insertion hole 120 and a second insertion hole 140 are formed to be vertically distanced from each other at opposite sides with respect to a center of the padlock body 100, and a fixing hole 160 is formed horizontally by crossing the first insertion hole 120.

Furthermore, the padlock body 100 may be provided with a mounting recess 170 in which a light emitting unit 600 is accommodated, and formed at a lower portion of the second insertion hole 140 to communicate therewith.

The padlock body 100 is made of a metal or a synthetic resin, and may be formed by joining together after separation, or may be integrally formed.

In a case where the padlock body 100 is made of the synthetic resin, it is easy to manufacture and is advantageous in preventing rusting due to rainwater, etc. In a case of using metal, rusting can be prevented by plating or coating a metal surface.

Further, the padlock body 100 may be provided with a memo insertion hole 110 into which a memo 112 with a message is inserted, and the memo insertion hole 110 may be opened or closed by a memo cover 720.

The memo cover 720 may be coupled to the memo insertion hole 110 by screwing or tight fitting.

The memo 112 can be directly inserted into the memo insertion hole 110. However, a container 740 capable of accommodating therein the memo 112 may be inserted into the memo insertion hole 110, and then the memo insertion hole 110 may be closed using the memo cover 720.

Referring to FIG. 2, the shackle 200 is formed by bending a round bar into a substantially ‘∩’ shape as in a general padlock. A long first leg of the shackle 200 is accommodated in the first insertion hole 120 and is coupled to the padlock body 100 by a fixing pin 500.

A short second leg of the shackle 200 remains separated from the padlock body 100 in an unlocked state of the padlock, and is accommodated in the second insertion hole 140 in a locked state of the padlock.

Specifically explained, the first leg of the shackle 200 is provided with a first locking groove 220 and a second locking groove 240 that are formed to be vertically distanced from each other.

The first locking groove 220 has a ring shape formed along the circumference of the round bar, such that when the fixing pin 500 is located in the first locking groove 220, the shackle 200 is rotatable. The first locking groove 220 has a tapered upper portion such that when the padlock is in a locked state by pressing the shackle 220, the fixing pin 500 can be easily moved to the second locking groove 240.

The second locking groove 240 is formed in a part of the circumference of the round bar at a position above the first locking groove 220, and is a part where the fixing pin 500 is located when the padlock is in a locked state by pressing the shackle 200.

The shackle 200 may be coupled with an O-ring 688 such that airtightness is maintained between the shackle 200 and the padlock body 100 in a locked state of the padlock.

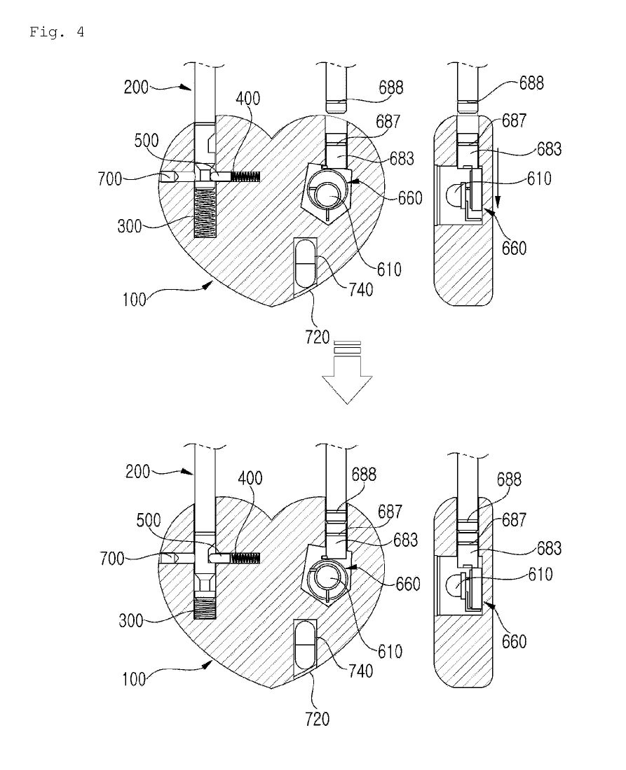

Referring to FIG. 4, a first elastic body 300 provides an elastic force acting upward to the first leg of the shackle 200 which is accommodated in the first insertion hole 120. Because the elastic force acts in a direction of pushing the shackle 200 out of the padlock body 100, the fixing pin 500 that is normally located in the first locking groove 220 is prevented from moving to the second locking groove 240, whereby the padlock can be maintained in an unlocked state.

The fixing pin 500 is a part that allows the padlock to be maintained in an unlocked state or a locked state, and is accommodated in the fixing hole 160 communicating with the first insertion hole 120. Herein, a second elastic body 400 is located between the fixing pin 500 and the fixing hole 160, whereby an elastic force acts on the fixing pin 500 in a direction toward the first insertion hole 120.

In other words, in an unlocked state of the padlock, the fixing pin 500 can be maintained in a state of being located in the first locking groove 220 by the second elastic body 400, while in a locked state of the padlock, the fixing pin 500 can be maintained in a state of being located in the second locking groove 240 by the second elastic body 400.

When the shackle 200 is coupled to the padlock body 100 in a state where the second elastic body 400 and the fixing pin 500 are accommodated in the fixing hole 160, a plug 700 is coupled to the fixing hole 160 and thus the fixing hole 160 is closed.

Referring to FIG. 2, the light emitting unit 600 is a part that is coupled to an interior or exterior of the padlock body 100 and serves to emit light in a locked state of the padlock, and includes: a light emitting element 610 coupled to the padlock body 100; a transparent portion 640 coupled to the padlock body 100 to cover the light emitting element 610 and transmitting light emitted from the light emitting element 610; a power supply portion 660 coupled to the padlock body 100 and supplying electric power to the light emitting element 610; and a lighting portion 680 electrically connecting the light emitting element 610 and the power supply portion 660 to each other in a locked state of the padlock.

The light emitting element 610 is a part that emits light using electric power supplied from the power supply portion 660, and may use a general bulb, preferably an LED having a longer lifespan and less power consumption than a general bulb.

The light emitting element 610 may be installed in the padlock body 100 to allow light to emit through the transparent portion 640 coupled to the padlock body 100, and may be installed at the exterior of the padlock body 100 by using the transparent portion 640 coupled to the padlock body 100.

The light emitting element 610 may use an image display device (not shown) instead of the LED that simply emits light. In a case where the image display device is used, a desired text or image by a user can be displayed on the image display device.

The text or image may be displayed on the image display device by using pre-input data, or by individually inputting data for each text or image into a separate memory (not shown).

The image display device refers to a liquid crystal display (LCD) panel, a thin film liquid crystal display (TFT-LCD) panel, an organic light emitting diode (OLED) panel, an active organic light emitting diode (AMOLED) panel, etc.

The transparent portion 640 may be coupled to the padlock body 100 using an adhesive, or by screwing or fitting. The transparent portion 640 may be coupled with an O-ring 686 such that in a state where the transparent portion 640 is coupled with and the padlock body 100, airtightness can be maintained therebetween.

The power supply portion 660 is a part that represents a battery for supplying electric power to the light emitting element 610 to emit light. Although a general cylindrical battery may be used, it is preferable that a button-shaped mercury battery is used.

Furthermore, the power supply portion 660 may be a disposable battery. In this case, a battery cover (not shown) may be provided in the padlock body 100 to replace the battery accommodated in the padlock body 100.

In addition, the power supply portion may be a rechargeable battery. In this case, a discharged battery may be removed from the padlock body 100, and then charged for re-installation, a terminal (not shown) to which an external power source such as an auxiliary battery is connected may be provided in the padlock body 100, or a solar panel (not shown) may be provided in the padlock body 100 to charge the battery using electric power produced therein.

The power supply portion 660 may supply electric power to the light emitting element 610 at equal to or less than a predetermined brightness by using an illuminance sensor (not shown) capable of measuring brightness of light, or may be provided with a timer (not shown) such that electric power is supplied to the light emitting element 610 in accordance with a predetermined time such as sunset time depending on the time of year.

In a case where the illuminance sensor or the timer is provided in the power supply portion 660, it is possible to supply electric power to the light emitting element 610 only in the dark conditions or in the evening after sunset so that the battery can be used more efficiently.

Furthermore, the power supply portion 660 may be provided with a separate power switch (not shown) that supplies or cuts off electric power to the light emitting element 610, such that whether to supply electric power to the light emitting element 610 in a locked state of the padlock can be selected.

In a case where the power switch coupled to the padlock body 100 partially protrudes from the exterior thereof, it is preferable that a separate waterproof treatment is performed. In a case where the power switch is installed in the memo insertion hole 110, the container 740 fitted in the memo insertion hole 110 may be allowed to be moved into the padlock body 100 by the memo cover 720 to operate the power switch.

The lighting unit 680 is a part that applies electric power supplied from the power supply portion 660 to the light emitting element 610 in a locked state of the padlock, and each embodiment thereof will be described below.

### First Embodiment

Referring to FIG. 4, a lighting portion 680 includes: a pressing pin 683 coupled to a second insertion hole 140 to move upward and downward; a first connection portion 681 provided between a first connection terminal 612 of a light emitting element 610 and a first electrode 662 of a power supply portion 660; and a second connection portion 682 provided between a second connection terminal 614 of the light emitting element 610 and a second electrode 664 of the power supply portion 660.

The first connection portion 681 always connects the first connection terminal 612 and the first electrode 662 to each other, and pushes the pressing pin 683 downward when the second leg of the shackle 200 is inserted into the padlock body 100. Then, the pressing pin 683 moves the power supply portion 660 downward, and the second connection portion 682 is brought into contact with the second electrode 664 so that electric power is supplied to the light emitting element 610 from the power supply portion 660.

The pressing pin 683 may be formed in various shapes as required, and a separate elastic body 800 may be provided between the pressing pin 683 and the padlock body 100 so as not to move the power supply portion 660 downward in an unlocked state of the padlock. A protrusion 589 may protrude outwardly to be stopped by a stopper 142 formed inwardly the second insertion hole 140 in the padlock body 100 such that the pressing pin 683 is prevented from being separated from the padlock body 100. The pressing pin 683 may be coupled with an O-ring 687 and may be coupled to the padlock body 100 such that in a state where the pressing pin 683 is coupled with the padlock body 100, airtightness can be maintained therebetween, which is the same as in the following embodiments.

The second leg of the shackle 200 can directly move the power supply portion 660 without the pressing pin 683, which is the same as in the following embodiments.

The first electrode 662 of the power supply portion 660 is a positive (+) or negative (−) electrode, and the second electrode 664 is a remaining electrode except for the first electrode 662, which is the same as in the following embodiments.

### Second Embodiment

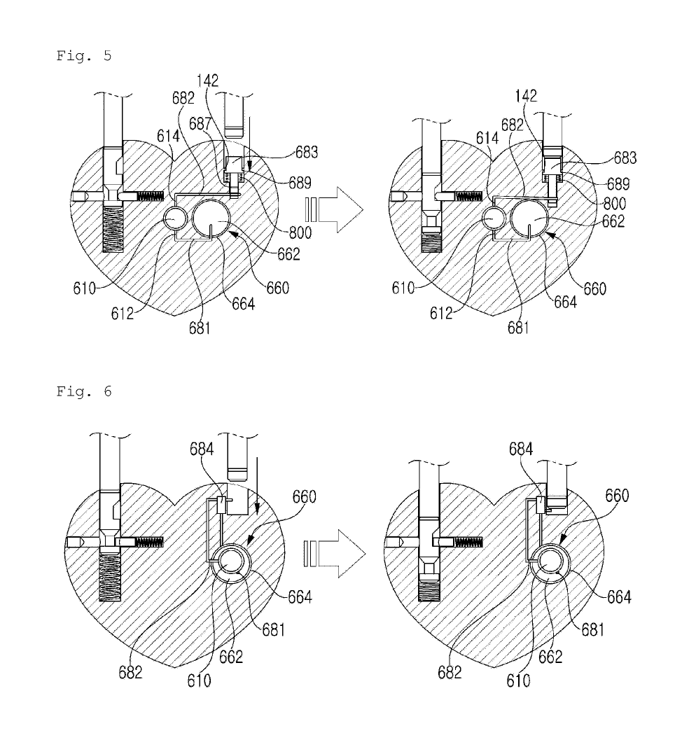

Referring to FIG. 5, a lighting portion 680 includes: a pressing pin 683 coupled to a second insertion hole 140 to move upward and downward; a first connection portion 681 provided between a first connection terminal 612 of a light emitting element 610 and a first electrode 662 of a power supply portion 660; and a second connection portion 682 provided between a second connection terminal 614 of the light emitting element 610 and a second electrode 664 of the power supply portion 660.

The first connection portion 681 always connects the first connection terminal 612 and the first electrode 662 to each other, and pushes the pressing pin 683 downward when the second leg of the shackle 200 is inserted into the padlock body 100. Then, the pressing pin 683 moves the power supply portion 660 downward, and the second connection portion 682 is bent downward to be brought into contact with the second electrode 664 so that electric power is supplied to the light emitting element 610 from the power supply portion 660.

### Third Embodiment

Referring to FIG. 6, a lighting portion 680 includes: a first connection portion 681 provided between a first connection terminal 612 of a light emitting element 610 and a first electrode 662 of a power supply portion 660; a second connection portion 682 provided between a second connection terminal 614 of the light emitting element 610 and a second electrode 664 of the power supply portion 660; and a switch 684 connected to the first connection portion 681 or the second connection portion 682 and applying electric power to the light emitting element 610.

For example, the first connection portion 681 always connects the first connection terminal 612 and the first electrode 662 to each other, and operates the switch 684 when the second leg of the shackle 200 is inserted into the padlock body 100 so that electric power is supplied to the light emitting element 610 from the power supply portion 660.

The switch 684 may be installed in the padlock body 100 to protrude toward the second insertion hole 140 and may be installed directly in the second insertion hole 140.

### Fourth Embodiment

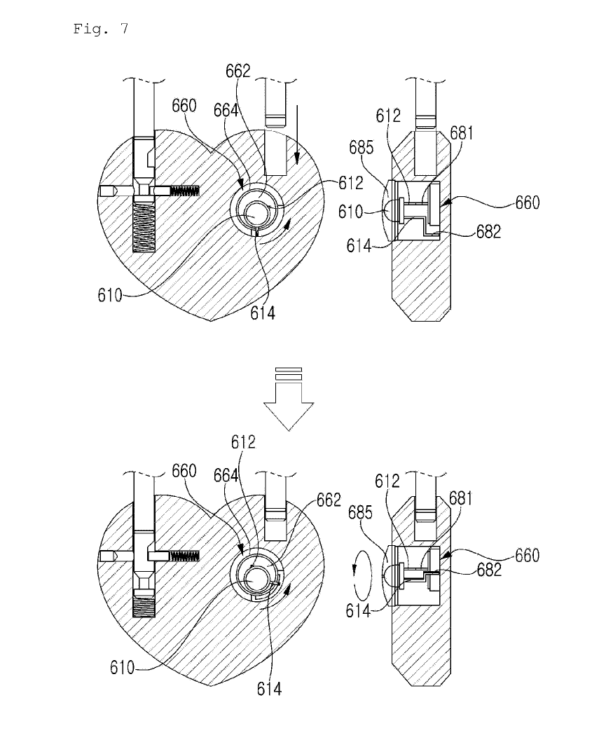

Referring to FIG. 7, a lighting portion 680 includes: a rotary cover 685 coupled to a padlock body 100; a first connection portion 681 coupled with a rotary cover 685 to connect a first connection terminal 612 of a light emitting element 610 and a first electrode 662 of a power supply portion 660 to each other; and a second connection portion 682 coupled with the rotary cover 685 to connect a second connection terminal 614 of the light emitting element 610 and a second electrode 664 of the power supply portion 660 to each other.

The rotary cover 685 is a part that covers the battery installed in the padlock body 100 and an upper side thereof, and the light emitting element 610 is installed in the rotary cover 685 so that when the rotary cover 685 is rotated, the light emitting element 610 is rotated together therewith.

The first connection portion 681 always connects the first connection terminal 612 and the first electrode 662 to each other. When the rotary cover 685 is rotated, the second connection portion 682, which is distanced from the second electrode 664, is brought into contact with the second electrode 664, so that electric power is supplied to the light emitting element 610 from the power supply portion 660.

The rotary cover 685 may be coupled with the O-ring 686 such that in a state where the rotary cover 685 is coupled with the padlock body 100, airtightness can be maintained therebetween.

Hereinafter, further embodiments of the light emitting unit 600 will be described.

### Fifth Embodiment

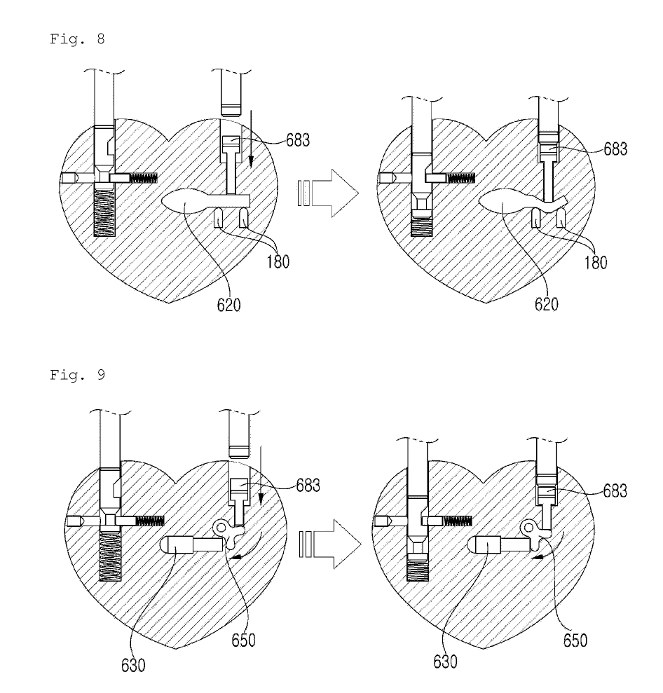

Referring to FIG. 8, a light emitting unit 600 includes: a chemical lighting device 620 accommodating chemical substances for emitting light in a tube made of a flexible material; and a pressing pin 683 coupled to a second insertion hole 140 to move upward and downward.

The chemical lighting device 620 is a light emitting material that emits light for a long time using a chemical reaction, and generally a glass ampoule is contained in a casing. When the chemical lighting device 620 is bent in the hands, the glass ampoule is broken and chemical substances therein come out and then mix with oxalate in the casing to cause a chemical reaction, thereby producing a bright light.

When the second leg of the shackle 200 is inserted into the padlock body 100, the pressing pin 683 is pushed downward. Then, the pressing pin 683 presses the chemical lighting device 620 to emit light.

Furthermore, the padlock body 100 may be provided with locking protrusions 180 positioned at a lower side of the chemical lighting device 620 to be distanced to face each other with respect to the pressing pin 683, such that the pressing pin 683 can bend the chemical lighting device 620 in a locked state of the padlock.

In other words, in a locked state of the padlock, the chemical lighting device 620 is located on the locking protrusions 180 and the pressing pin 683 is moved between the locking protrusions 180, so that the chemical lighting device 620 is easily bent.

### Sixth Embodiment

Referring to FIG. 9, a light emitting unit 600 includes: an electric chemical lighting device 630 including an LED and a battery supplying electric power to the LED; a rotary pin 650 hinged to a padlock body 100; and a pressing pin 683 coupled to a second insertion hole 140 to move upward and downward.

When the second leg of the shackle 200 is inserted into the padlock body 100, the pressing pin 683 is pushed downward and then the pressing pin 683 pushes the rotary pin 650, so that the rotary pin 650 is rotated around a hinge shaft and presses the electric chemical lighting device 630 to emit light.

The electric chemical lighting device 630 is used for replacing the chemical lighting device containing chemical substances therein, and is composed of a light emitting body made of an LED, etc. and a battery for supplying electric power to the LED. When the battery is rotated or pressed, the LED is activated.

Hereinafter, a configuration for discharging rainwater, etc. that has flowed into the padlock body 100 will be described.

The padlock body 100 may be provided with discharge holes 190 that are respectively provided at lower portions of the first insertion hole 120 and the mounting recess 170 and lead to outside the padlock body 100, such that rainwater, etc. is discharged through the discharge holes 190 when flowing into the padlock body 100.

Thus, rainwater, etc. is prevented primarily from flowing into the padlock body 100 by the O-rings 686, 687, and 688. Even when rainwater, etc. flows into the padlock body 100, rainwater, etc. is allowed to naturally flow to outside the padlock body 100 through the discharge holes 190, so that electronic components installed in the padlock body 100 can be safely protected from rainwater, etc.

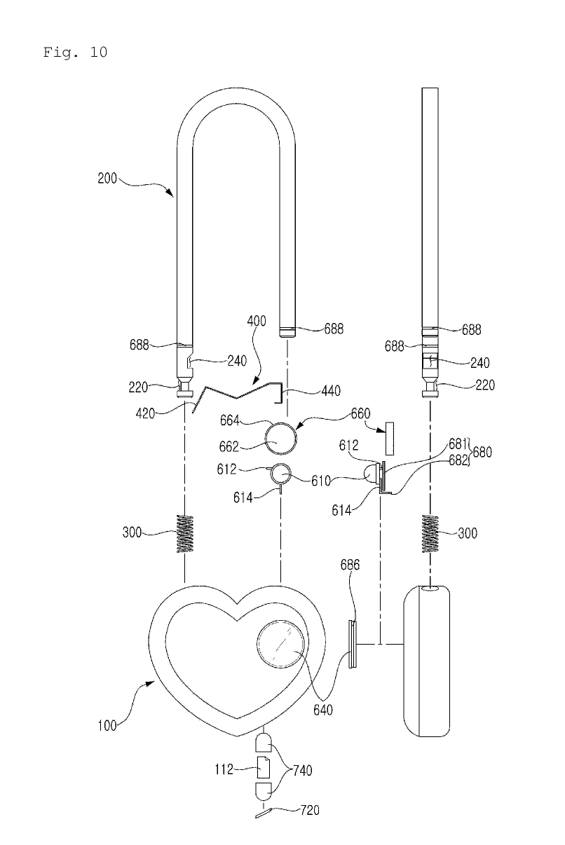

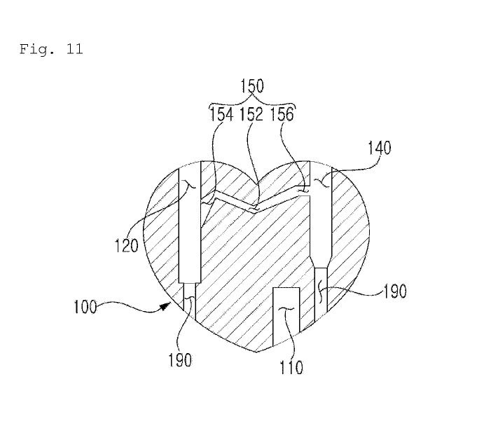

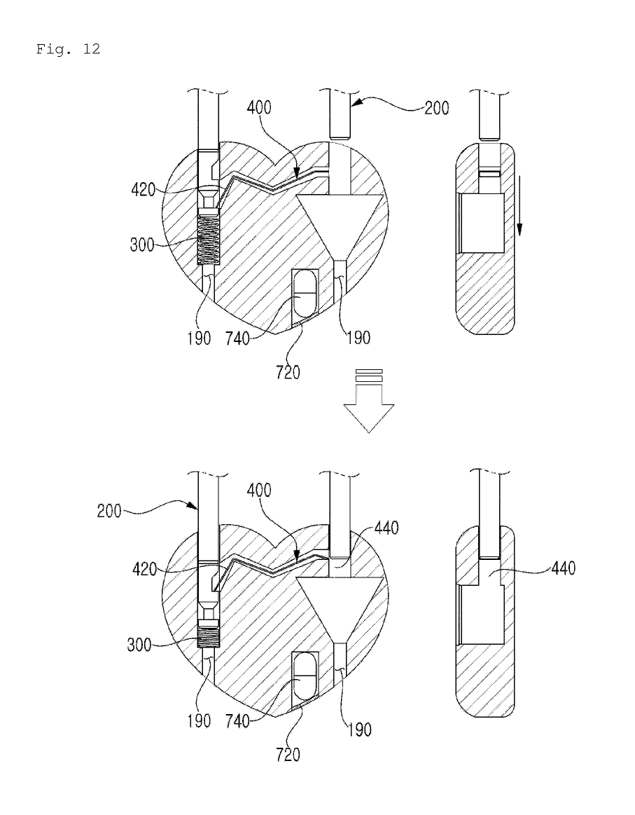

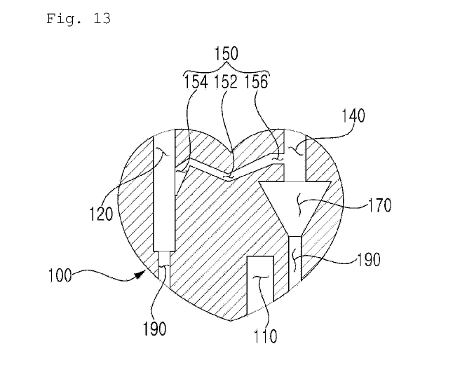

Referring to FIGS. 10 to 14, an improved padlock includes: a padlock body 100 provided with first and second insertion holes 120 and 140 formed vertically to be distanced from each other and an installation hole 150 formed horizontally and communicating with the first and second insertion holes 120 and 140; a bent round bar-shaped shackle 200 configured such that a first leg thereof, which is provided with first and second locking grooves 220 and 240 formed to be vertically distanced from each other, is accommodated in the first insertion hole 120, and a second leg thereof is distanced from the padlock body 100 in an unlocked state of the padlock and is inserted into the padlock body 100 through the second insertion hole 140 in a locked state of the padlock; a first elastic body 300 accommodated in the first insertion hole 120 to be in contact with the first leg of the shackle 200; and an elastic piece 400 accommodated in the installation hole 150 and provided at a first side thereof with a first elastic bar 420 located in the first locking groove 220 in the unlocked state of the padlock and located in the second locking groove 240 in the locked state of the padlock.

An improved padlock according to another embodiment of the present invention includes: a padlock body 100 provided with first and second insertion holes 120 and 140 formed vertically to be distanced from each other, an installation hole 150 formed horizontally and communicating with the first and second insertion holes 120 and 140, and a mounting recess 170 communicating with the second insertion hole 140; a bent round bar-shaped shackle 200 configured such that a first leg thereof, which is provided with first and second locking grooves 220 and 240 formed to be vertically distanced from each other, is accommodated in the first insertion hole 120, and a second leg thereof is distanced from the padlock body 100 in an unlocked state of the padlock and is inserted into the padlock body 100 through the second insertion hole 140 in a locked state of the padlock; a first elastic body 300 accommodated in the first insertion hole 120 to be in contact with the first leg of the shackle 200; an elastic piece 400 accommodated in the installation hole 150, and provided at a first side thereof with a first elastic bar 420 located in the first locking groove 220 in the unlocked state of the padlock and located in the second locking groove 240 in the locked state of the padlock, and at a second side thereof with a second elastic bar 440 curved downward by the second leg of the shackle 200 in the locked state of the padlock; and a light emitting unit 600 coupled to the padlock body 100 and operating in the locked state of the padlock.

Referring to FIGS. 10 to 14, the padlock body 100, which is a part where the shackle 200 is inserted and withdrawn into and from an upper portion thereof, is configured such that the first insertion hole 120 and the second insertion hole 140 are formed vertically to be distanced from each other at opposite sides with respect to a center of the padlock body 100, and the installation hole 150 communicating with the first and second insertions hole 120 and 140 is formed horizontally.

The installation hole 150 is a space for installing the elastic piece 400 in the padlock body, and is formed horizontally to communicate with the first and second insertion holes 120 and 140.

Specifically explained, the installation hole 150 includes a first installation hole 152 located centrally, a second installation hole 154 located at a first side of the first installation hole 152 and providing a space in which the first elastic bar 420 is movable, and a third installation hole 156 located at a second side of the first installation hole 152 and providing a space in which the second elastic bar 440 is movable.

The first installation hole 152 is a space for fixing a central portion of the elastic piece 400, and is configured such that a central portion thereof is curved downward whereby the elastic piece 400 is prevented from moving horizontally.

In other words, the installation hole 150 is configured such that with respect to the first installation hole 152, the second installation hole 154 in which the first elastic bar 420 is located is formed at the first side, and the third installation hole in which the second elastic bar 440 is located is formed at the second side.

In a case where the shackle 200 is moved downward and the padlock is changed from an unlocked state to a locked state, the first elastic bar 420 and the second elastic bar 440 of the elastic piece 400 are curved downward. Herein, the second installation hole 154 provides a space in which the first elastic bar 420 can be curved, and the third installation hole 156 provides a space in which the second elastic bar can be curved.

Furthermore, the padlock body 100 is provided with the mounting recess 170 in which the light emitting unit 600 is accommodated and formed at a lower portion of the second insertion hole 140 to communicate therewith.

The padlock body 100 is made of a metal or a synthetic resin, and may be formed by joining together after separation, or may be integrally formed.

In a case where the padlock body 100 is made of the synthetic resin, it is easy to manufacture and is advantageous in preventing rusting due to rainwater, etc. In a case of using metal, rusting can be prevented by plating or coating a metal surface.

Further, the padlock body 100 may be provided with a memo insertion hole 110 into which a memo 112 with a message is inserted, and the memo insertion hole 110 may be opened or closed by a memo cover 720.

The memo cover 720 may be coupled to the memo insertion hole 110 by screwing or tight fitting.

The memo 112 can be directly inserted into the memo insertion hole 110. However, a container 740 capable of accommodating therein the memo 112 may be inserted into the memo insertion hole 110, and then the memo insertion hole 110 may be closed using the memo cover 720.

Referring to FIG. 10, the shackle 200 is formed by bending a round bar into a substantially ‘∩’ shape as in a general padlock. A long first leg of the shackle 200 is accommodated in the first insertion hole 120 and is prevented from being separated from the padlock body 100 by the first elastic bar 420 of the elastic piece 400.

A short second leg of the shackle 200 remains separated from the padlock body 100 in an unlocked state of the padlock, and is accommodated in the second insertion hole 140 in a locked state of the padlock.

Specifically explained, the first leg of the shackle 200 is provided with the first locking groove 220 and the second locking groove 240 that are formed to be vertically distanced from each other.

The first locking groove 220 has a ring shape formed along the circumference of the round bar, such that when the first elastic bar 420 is located in the first locking groove 220, the shackle 200 is rotatable. The first locking groove 220 has a tapered upper portion such that when the padlock is in a locked state by pressing the shackle 220, the first elastic bar 420 can be easily moved to the second locking groove 240.

The second locking groove 240 is formed in a part of the circumference of the round bar at a position above the first locking groove 220, and is a part where the first elastic bar 420 is located when the padlock is in a locked state by pressing the shackle 200.

Furthermore, the shackle 200 may be coupled with the O-ring 688 such that airtightness is maintained between the shackle 200 and the padlock body 100 in a locked state of the padlock.

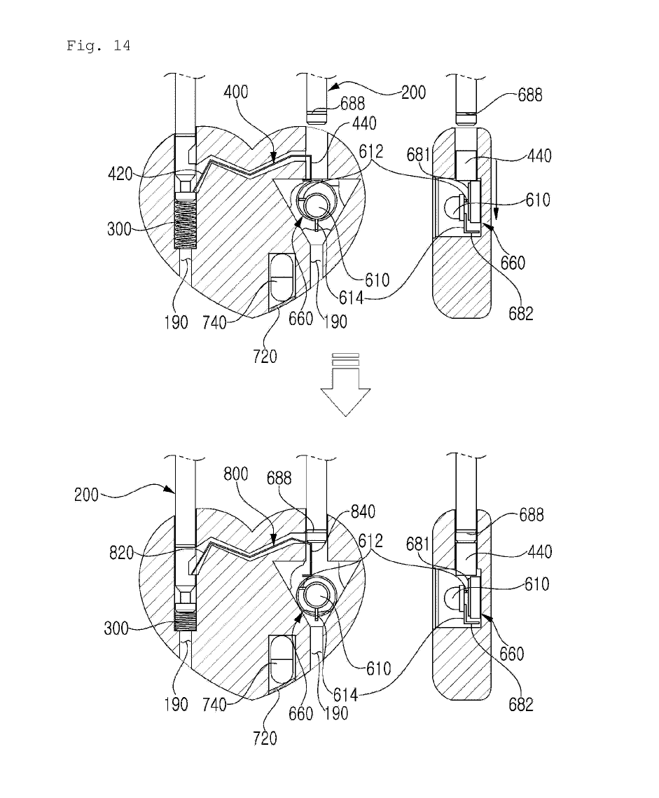

Referring to FIG. 14, the first elastic body 300 provides an elastic force acting upward to the first leg of the shackle 200 which is accommodated in the first insertion hole 120. Because the elastic force acts in a direction of pushing the shackle 200 out of the padlock body 100, the first elastic bar 420 that is normally located in the first locking groove 220 is prevented from moving to the second locking groove 240, whereby the padlock can be maintained in an unlocked state.

The elastic piece 400 is a part that operates the light emitting unit 600 in a locked state of the padlock in addition to allowing the padlock to be maintained in an unlocked state or a locked state, and is placed in the installation hole 150 that communicates with the first and second insertion holes 120 and 140.

The first elastic bar 420 of the elastic piece 400 is a part that is inserted into the installation hole 150 and an opposite sides thereof are pressed downward, thereby exerting an elastic force in an opposite direction thereto.

In other words, the first elastic bar 420 can be maintained in a state of being located in the first locking groove 220 of the shackle 200 due to its own shape in an unlocked state of the padlock and the first elastic bar 420 can be maintained in the shackle 200. When the shackle 200 is moved downward, the first elastic bar 420 is curved in the second installation hole 154 and then moved to the second locking groove 240 of the shackle 200, so that the padlock can be maintained in a locked state.

The first elastic bar 420 is inclined downward whereby the first elastic bar 420 is prevented from being moved back to the first locking groove 220 after being moved to the second locking groove 240.

In addition, the second elastic bar 440 of the elastic piece 400 is a part that is curved downward to operate the light emitting unit 600 when the shackle 200 is moved downward, and may be formed parallel to the vertical second insertion hole 140 to be moved downward along the second insertion hole 14. Herein, an end of the second elastic bar 440 may be bent horizontally such that a contact area with the light emitting unit 600 is increased.

Referring to FIG. 10, a light emitting unit 600 is a part that is coupled to an interior or exterior of the padlock body 100 and serves to emit light in a locked state of the padlock, and includes: a light emitting element 610 installed in a mounting recess 170 of a padlock body 100; a transparent portion 640 coupled to the mounting recess 170 of the padlock body 100 to cover the light emitting element 610 and transmitting light emitted from the light emitting element 610 to the outside of the padlock body 100; a power supply portion 660 installed in the mounting recess 170 of the padlock body 100 and supplying electric power to the light emitting element 610; and a lighting portion 680 electrically connecting the light emitting element 610 and the power supply portion 660 to each other in the locked state of the padlock.

The light emitting element 610 is a part that emits light using electric power supplied from the power supply portion 660, and may use a general bulb, preferably an LED having a longer lifespan and less power consumption than a general bulb.

The light emitting element 610 may be installed in the mounting recess 170 of the padlock body 100 to allows light to emit through the transparent portion 640 coupled to the mounting recess 170, and may be installed at the exterior of the padlock body 100 by using the transparent portion 640 coupled to the padlock body 100.

The light emitting element 610 may use an image display device (not shown) instead of the LED that simply emits light. In a case where the image display device is used, a desired text or image by a user can be displayed on the image display device.

The text or image may be displayed on the image display device by using pre-input data, or may be selected to be displayed on the image display device by individually inputting data for each text or item into a separate memory (not shown).

Herein, the image display device refers to a liquid crystal display (LCD) panel, a thin film liquid crystal display (TFT-LCD) panel, an organic light emitting diode (OLED) panel, an active organic light emitting diode (AMOLED) panel, etc.

The transparent portion 640 may be coupled to the padlock body 100 using an adhesive, or by screwing or fitting. The transparent portion 640 may be coupled with an O-ring 686 such that in a state where the transparent portion 640 is coupled with the padlock body 100, airtightness can be maintained therebetween.

The power supply portion 660 is a part that represents a battery for supplying electric power to the light emitting element 610 to emit light. Although a general cylindrical battery may be used, it is preferable that a button-shaped mercury battery is used.

Furthermore, the power supply portion 660 may be a disposable battery. In this case, a battery cover (not shown) may be provided in the padlock body 100 to replace the battery accommodated in the padlock body 100.

In addition, the power supply portion may be a rechargeable battery. In this case, a discharged battery may be removed from the padlock body 100, and then charged for re-installation, a terminal (not shown) to which an external power source such as an auxiliary battery is connected may be provided in the padlock body 100, or a solar panel (not shown) may be provided in the padlock body 100 to charge the battery using electric power produced therein.

The power supply portion 660 may supply electric power to the light emitting element 610 at equal to or less than a predetermined brightness by using an illuminance sensor (not shown) capable of measuring brightness of light, or may be provided with a timer (not shown) such that electric power is supplied to the light emitting element 610 in accordance with a predetermined time such as sunset depending on the time of year.

In a case where the illuminance sensor or the timer is provided in the power supply portion 660, it is possible to supply electric power to the light emitting element 610 only in the dark conditions or in the evening after sunset so that the battery can be used more efficiently.

Furthermore, the power supply portion 660 may be provided with a separate power switch (not shown) that supplies or cuts off electric power to the light emitting element 610, such that whether to supply electric power to the light emitting element 610 in a locked state of the padlock can be selected.

In a case where the power switch coupled to the padlock body 100 partially protrudes from the exterior thereof, it is preferable that a separate waterproof treatment is performed. In a case where the power switch is installed in the memo insertion hole 110, the container 740 fitted in the memo insertion hole 110 may be allowed to move into the padlock body 100 by the memo cover 720 to operate the power switch.

The lighting unit 680 is a part that applies electric power supplied from the power supply portion 660 to the light emitting element 610 in a locked state of the padlock, and each embodiment thereof will be described below.

### Seventh Embodiment

Referring to FIGS. 10 to 14, a lighting portion 680 includes: a first connection portion 681 provided between a first connection terminal 612 of a light emitting element 610 and a first electrode 662 of a power supply portion 660; and a second connection portion 682 provided between a second connection terminal 614 of the light emitting element 610 and a second electrode 664 of the power supply portion 660.

The first connection portion 681 always connects the first connection terminal 612 and the first electrode 662 to each other, and pushes the second elastic bar 440 of the elastic piece 400 downward when the second leg of the shackle 200 is inserted into the padlock body 100. Then, the second elastic bar 440 having been moved downward moves the power supply portion 660 downward, and the second connection portion 682 which is not in contact with the second electrode 664 in an unlocked state of the padlock is moved downward and thus brought into contact with the second electrode 664, so that electric power is supplied from the power supply portion 660 to the light emitting element 610.

The second leg of the shackle 200 can directly move the power supply portion 660 without the second elastic bar 440 of the elastic piece 400, the first electrode 662 of the power supply portion 660 is a positive (+) or negative (−) electrode, and the second electrode 664 of the power supply portion 660 is a remaining electrode except for the first electrode 662, which is the same as in the following embodiments.

### Eighth Embodiment

Referring to FIG. 15, a lighting portion 680 includes: a first connection portion 681 provided between a first connection terminal 612 of a light emitting element 610 and a first electrode 662 of a power supply portion 660; and a second connection portion 682 provided between a second connection terminal 614 of the light emitting element 610 and a pressing pin 683.

The first connection portion 681 always connects the first connection terminal 612 and the first electrode 662 to each other, and pushes the second elastic bar 440 of the elastic piece 400 downward when the second leg of the shackle 200 is inserted into the padlock body 100. Then, the second elastic bar 440 having been moved downward moves the second connection portion 682 downward, and the second connection portion 682 is curved downward and thus brought into contact with the second electrode 664, so that electric power is supplied from the power supply portion 660 to the light emitting element 610.

### Ninth Embodiment

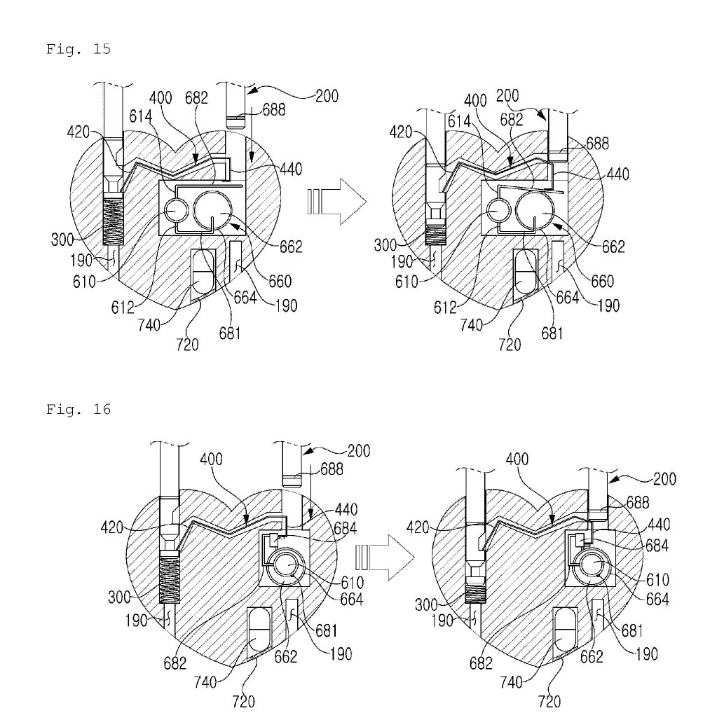

Referring to FIG. 16, a lighting portion 680 includes: a first connection portion 681 provided between a first connection terminal 612 of a light emitting element 610 and a first electrode 662 of a power supply portion 660; a second connection portion 682 provided between a second connection terminal 614 of the light emitting element 610 and a second electrode 664 of the power supply portion 660; and a switch 684 connected to the first connection portion 681 or the second connection portion 682 and applying electric power to the light emitting element 610.

For example, the first connection portion 681 always connects the first connection terminal 612 and the first electrode 662 to each other, and pushes downward the second elastic bar 440 of the elastic piece 400 when the second leg of the shackle 200 is inserted into the padlock body 100. Then, the second elastic bar 440 having been pushed downward operates the switch 684, so that electric power is supplied to the light emitting element 610 from the power supply portion 660.

The switch 684 may be installed in the second insertion hole 140 or the mounting recess 170.

### Tenth Embodiment

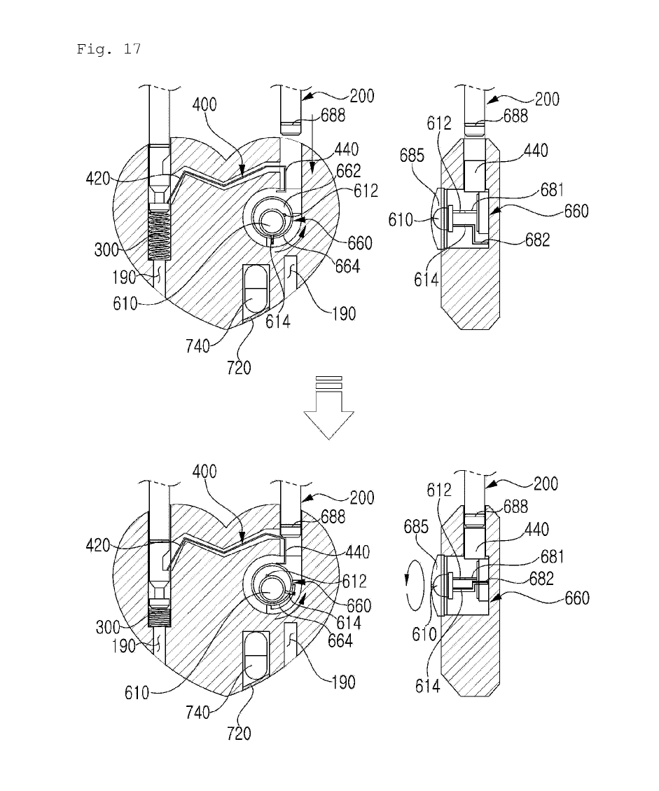

Referring to FIG. 17, a lighting portion 680 includes: a rotary cover 685 coupled to a mounting recess 170 of the padlock body 100 to which a transparent portion 640 is coupled; a first connection portion 681 coupled with the rotary cover 685 to connect a first connection terminal 612 of a light emitting element 610 and a first electrode 662 of a power supply portion 660 to each other; and a second connection portion 682 coupled with the rotary cover 685 to connect a second connection terminal 614 of the light emitting element 610 and a second electrode 664 of the power supply portion 660 to each other.

The rotary cover 685 is a part that covers the power supply portion 660 installed in the padlock body 100, and the light emitting element 610 is installed in the rotary cover 685 so that when the rotary cover 685 is rotated, the light emitting element 610 is rotated together therewith.

The first connection portion 681 always connects the first connection terminal 612 and the first electrode 662 to each other. When the rotary cover 685 is rotated, the second connection portion 682, which is distanced from the second electrode 664, is brought into contact with the second electrode 664, so that electric power is supplied to the light emitting element 610 from the power supply portion 660.

The rotary cover 685 may be coupled with the O-ring 686 such that in a state where the rotary cover 685 is coupled with the padlock body 100, airtightness can be maintained therebetween.

Hereinafter, further embodiments of the light emitting unit 600 will be described.

### Eleventh Embodiment

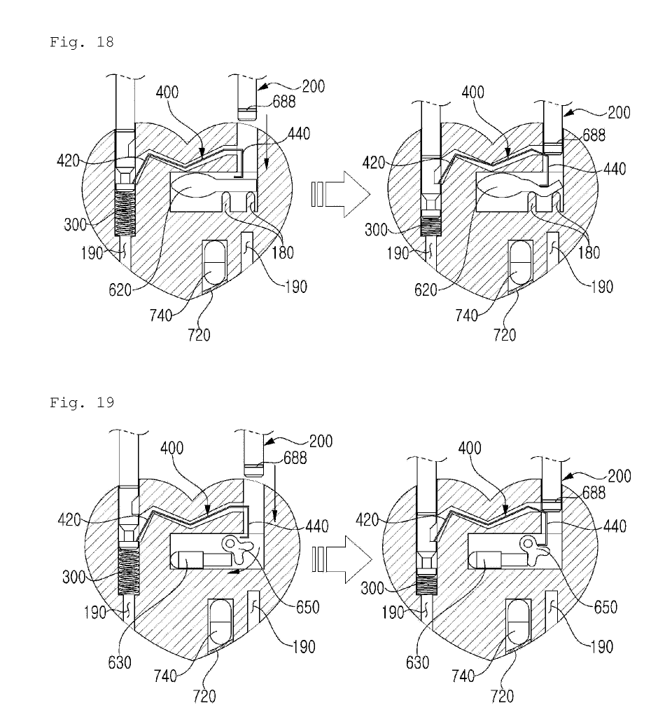

Referring to FIG. 18, a light emitting unit 600 includes: a chemical lighting device 620 accommodating chemical substances for emitting light in a tube made of a flexible material; and a transparent portion 640 coupled to a mounting recess 170 of a padlock body 100 and transmitting light emitted from the chemical lighting device 620.

The chemical lighting device 620 is a light emitting material that emits light for a long time using a chemical reaction. In general, a glass ampoule is contained in a casing. When the chemical lighting device 620 is bent in the hands, the glass ampoule is broken and chemical substances therein come out and then mix with oxalate in the casing to cause a chemical reaction, thereby producing a bright light.

When the second leg of the shackle 200 is inserted into the padlock body 100, the second elastic bar 440 of the elastic piece 400 is pushed downward. Then, the second elastic bar 440 having been pushed downward presses the chemical lighting device 620 to emit light.

Furthermore, the padlock body 100 may be provided with locking protrusions 180 positioned at a lower side of the chemical lighting device 620 to be distanced to face each other with respect to the pressing pin 683, such that the pressing pin 683 can bend the chemical lighting device 620 in a locked state of the padlock.

In other words, in a locked state of the padlock, the chemical lighting device 620 is located on the locking protrusions 180 and the second elastic bar 440 is moved between the locking protrusions 180, so that the chemical lighting device 620 is easily bent.

### Twelfth Embodiment

Referring to FIG. 19, a light emitting unit 600 includes: an electric chemical lighting device 630 including an LED and a battery supplying electric power to the LED; a transparent portion 640 coupled to a mounting recess 170 of a padlock body 100 and transmitting light emitted from the electric chemical lighting device 630; and a rotary pin 650 hinged to the padlock body 100.

When the second leg of the shackle 200 is inserted into the padlock body 100, the second elastic bar 440 of the elastic piece 400 is pushed downward. Then, the second elastic bar 440 having been pushed downward pushes the rotary pin 650, so that the rotary pin 650 is rotated around a hinge shaft and presses the electric chemical lighting device 630 to emit light.

The electric chemical lighting device 630 is used for replacing the chemical lighting device containing chemical substances therein, and is composed of a light emitting body made of an LED, etc. and a battery for supplying electric power to the LED. When the battery is rotated or pressed, the LED is activated.

Hereinafter, a configuration for discharging rainwater, etc. that has flowed into the padlock body 100 will be described.

The padlock body 100 may be provided with discharge holes 190 that are respectively provided at lower portions of the first insertion hole 120 and the mounting recess 170 and lead to outside the padlock body 100, such that rainwater, etc. is discharged through the discharge holes 190 when flowing into the padlock body 100.

Thus, rainwater, etc. is prevented primarily from flowing into the padlock body 100 by the O-rings 686, 687, and 688. Even when rainwater, etc. flows into the padlock body 100, rainwater, etc. is allowed to naturally flow to outside the padlock body 100 through the discharge holes 190, so that electronic components installed in the padlock body 100 can be safely protected from rainwater, etc.

Although the preferred embodiments of the present invention have been disclosed for illustrative purposes, specific structural and functional descriptions of embodiments of the present invention disclosed herein are only for illustrative purposes of the preferred embodiments of the present invention, and the present description is not intended to represent all of the technical spirit of the present invention. On the contrary, the present invention is intended to cover not only the exemplary embodiments, but also various alternatives, modifications, equivalents and other embodiments that may be included within the spirit and scope of the present invention as defined by the appended claims. It is thus well known to those skilled in that art that the present invention is not limited to the embodiment disclosed in the detailed description, and the patent right of the present invention should be defined by the scope and spirit of the invention as disclosed in the accompanying claims. Accordingly, it should be understood that the present invention includes various modifications, additions and substitutions without departing from the scope and spirit of the invention as disclosed in the accompanying claims.

### DESCRIPTION OF THE REFERENCE NUMERALS IN THE DRAWINGS

| 100: padlock body | 110: memo insertion hole |
|---|---|
| 112: memo | 120: first insertion hole |
| 140: second insertion hole | 142: stopper |
| 150: installation hole | 152: first installation hole |
| 154: second installation hole | |
| 156: third installation hole | |
| 160: fixing hole | 170: mounting recess |
| 180: locking protrusions | 190: discharge hole |
| 200: shackle | 220: first locking groove |
| 240: second locking groove | 300: first elastic body |
| 400: second elastic body or elastic piece | |
| 420: first elastic bar | |
| 440: second elastic bar | 500: fixing pin |
| 600: light emitting unit | 610: light emitting element |
| 612: first connection terminal | |
| 614: first connection terminal | |
| 620: chemical lighting device | |
| 630: electric chemical lighting device | |
| 640: transparent portion | 650: rotary pin |
| 660: power supply portion | 662: first electrode |
| 664: second electrode | 680: lighting portion |
| 681: first connection portion | |
| 682: second connection portion | |
| 683: pressing pin | 684: switch |
| 685: rotary cover | 686: O-ring |
| 687: O-ring | 688: O-ring |
| 700: plug | 720: memo cover |

740: container

1. A padlock, comprising:
a padlock body provided with first and second insertion holes formed vertically and a fixing hole formed horizontally and communicating with the first insertion hole;
a bent round bar-shaped shackle configured such that a first leg thereof, which is provided with first and second locking grooves formed to be vertically distanced from each other, is accommodated in the first insertion hole, and a second leg thereof is distanced from the padlock body in an unlocked state of the padlock and is inserted into the padlock body through the second insertion hole in a locked state of the padlock;
a first elastic body accommodated in the first insertion hole to be in contact with the first leg of the shackle;
a second elastic body accommodated in the fixing hole;
a fixing pin configured such that a first side thereof is inserted into the fixing hole to be in contact with the second elastic body, and a second side thereof is located in the first locking groove in the unlocked state of the padlock and is located in the second locking groove in the locked state of the padlock;
a light emitting unit coupled to the padlock body and operating in the locked state of the padlock.

2. A padlock, comprising:
a padlock body provided with first and second insertion holes formed vertically to be distanced from each other and an installation hole formed horizontally and communicating with the first and second insertion holes;
a bent round bar-shaped shackle configured such that a first leg thereof, which is provided with first and second locking grooves formed to be vertically distanced from each other, is accommodated in the first insertion hole, and a second leg thereof is distanced from the padlock body in an unlocked state of the padlock and is inserted into the padlock body through the second insertion hole in a locked state of the padlock;
a first elastic body accommodated in the first insertion hole to be in contact with the first leg of the shackle; and
an elastic piece accommodated in the installation hole and provided at a first side thereof with a first elastic bar located in the first locking groove in the unlocked state of the padlock and located in the second locking groove in the locked state of the padlock.

3. A padlock, comprising:
a padlock body provided with first and second insertion holes formed vertically to be distanced from each other, an installation hole formed horizontally and communicating with the first and second insertion holes, and a mounting recess communicating with the second insertion hole;
a bent round bar-shaped shackle configured such that a first leg thereof, which is provided with first and second locking grooves formed to be vertically distanced from each other, is accommodated in the first insertion hole, and a second leg thereof is distanced from the padlock body in an unlocked state of the padlock and is inserted into the padlock body through the second insertion hole in a locked state of the padlock;
a first elastic body accommodated in the first insertion hole to be in contact with the first leg of the shackle;
an elastic piece accommodated in the installation hole, and provided at a first side thereof with a first elastic bar located in the first locking groove in the unlocked state of the padlock and located in the second locking groove in the locked state of the padlock, and at a second side thereof with a second elastic bar curved downward by the second leg of the shackle in the locked state of the padlock; and
a light emitting unit coupled to the padlock body and operating in the locked state of the padlock.

4. The padlock of claim 1, wherein the light emitting unit includes:
a light emitting element coupled to the padlock body;
a transparent portion coupled to the mounting recess of the padlock body and transmitting light emitted from the light emitting element;
a power supply portion coupled to the padlock body to be movable upward and downward, and provided with first and second electrodes to supply electric power to the light emitting element; and
a lighting portion electrically connecting the light emitting element and the power supply portion to each other in the locked state of the padlock.

5. The padlock of claim 3, wherein the light emitting unit includes:
a light emitting element coupled to the padlock body;
a transparent portion coupled to the mounting recess of the padlock body and transmitting light emitted from the light emitting element;
a power supply portion coupled to the padlock body to be movable upward and downward, and provided with first and second electrodes to supply electric power to the light emitting element; and
a lighting portion electrically connecting the light emitting element and the power supply portion to each other in the locked state of the padlock.

6. The padlock of claim 5, wherein the installation hole includes:
a first installation hole located centrally;
a second installation hole located at a first side of the first installation hole and providing a space in which the first elastic bar is movable; and
a third installation hole located at a second side of the first installation hole and providing a space in which the second elastic bar is movable.

7. The padlock of claim 4, wherein the lighting portion includes:
a first connection portion provided between a first connection terminal of the light emitting element and the first electrode of the power supply portion; and
a second connection portion provided between a second connection terminal of the light emitting element and the second electrode of the power supply portion,
wherein in the locked state of the padlock, the power supply portion is moved downward, so that the second connection portion is brought into contact with the second electrode.

8. The padlock of claim 6, wherein the lighting portion includes:
a first connection portion provided between a first connection terminal of the light emitting element and the first electrode of the power supply portion; and
a second connection portion provided between a second connection terminal of the light emitting element and the second electrode of the power supply portion,
wherein in the locked state of the padlock, the power supply portion is moved downward, so that the second connection portion is brought into contact with the second electrode.

9. The padlock of claim 4, wherein the lighting portion includes:
a pressing pin coupled to the second insertion hole and moved downward by the second leg of the shackle inserted into the padlock body;
a first connection portion provided between a first connection terminal of the light emitting element and the first electrode of the power supply portion; and
a second connection portion provided between a second connection terminal of the light emitting element and the pressing pin,
wherein in the locked state of the padlock, the power supply portion is moved downward by the pressing pin, so that the second connection portion is brought into contact with the second electrode.

10. The padlock of claim 4, wherein the lighting portion includes:
a first connection portion provided between a first connection terminal of the light emitting element and the first electrode of the power supply portion;
a second connection portion provided between a second connection terminal of the light emitting element and the second electrode of the power supply portion; and
a switch connected to the first connection portion or the second connection portion and applying the electric power to the light emitting element,
wherein in the locked state of the padlock, the switch electrically connects the light emitting element and the power supply portion to each other.

11. The padlock of claim 6, wherein the lighting portion includes:
a first connection portion provided between a first connection terminal of the light emitting element and the first electrode of the power supply portion;
a second connection portion provided between a second connection terminal of the light emitting element and the second electrode of the power supply portion; and
a switch connected to the first connection portion or the second connection portion and applying the electric power to the light emitting element,
wherein in the locked state of the padlock, the switch electrically connects the light emitting element and the power supply portion to each other.

12. The padlock of claim 4, wherein the lighting portion includes:
a rotary cover coupled to the padlock body;
a first connection portion coupled with the rotary cover to connect a first connection terminal of the light emitting element and the first electrode of the power supply portion to each other; and
a second connection portion coupled with the rotary cover to connect a second connection terminal of the light emitting element and the second electrode of the power supply portion to each other,
wherein when the rotary cover is rotated, the second connection portion is brought into contact with the second electrode.

13. The padlock of claim 6, wherein the lighting portion includes:
a rotary cover coupled to the mounting recess of the padlock body to which the transparent portion is coupled;
a first connection portion coupled with the rotary cover to connect a first connection terminal of the light emitting element and the first electrode of the power supply portion to each other; and
a second connection portion coupled to the rotary cover to connect a second connection terminal of the light emitting element and the second electrode of the power supply portion to each other,
wherein when the rotary cover is rotated, the second connection portion is brought into contact with the second electrode.

14. The padlock of claim 13, wherein the rotary cover is coupled with an O-ring such that in a state where the rotary cover is coupled to the padlock body, airtightness is maintained therebetween.

15. The padlock of claim 1, wherein the light emitting unit includes:
a chemical lighting device accommodating chemical substances for emitting light in a tube made of a flexible material;
a transparent portion coupled to the padlock body to cover the chemical lighting device and transmitting the light emitted from the chemical lighting device; and
a pressing pin coupled to the second insertion hole to move upward and downward,
wherein in the locked state of the padlock, the pressing pin is moved downward and presses the chemical lighting device to emit the light.

16. The padlock of claim 3, wherein the light emitting unit includes:
a chemical lighting device accommodating chemical substances for emitting light in a tube made of a flexible material; and
a transparent portion coupled to the mounting recess of the padlock body and transmitting the light emitted from the chemical lighting device,
wherein in the locked state of the padlock, the second elastic bar moved downward presses the chemical lighting device to emit the light.

17. The padlock of claim 3, wherein the light emitting unit includes:
an electric chemical lighting device including an LED and a battery supplying electric power to the LED;
a transparent portion coupled to the mounting recess of the padlock body and transmitting light emitted from the electric chemical lighting device; and
a rotary pin hinged to the padlock body,
wherein in the locked state of the padlock, the second elastic bar moved downward rotates the rotary pin to operate the electric chemical lighting device.

18. The padlock of claim 3, wherein the padlock body is provided with a discharge hole that is provided at a lower portion of the first insertion hole or the second insertion hole and leads to outside the padlock body, such that a fluid flowing into the padlock body is discharged through the discharge holes.

19. The padlock of claim 3, wherein the padlock body is provided with a memo insertion hole storing a memo therein, and is further provided with a memo cover coupled to the memo insertion hole to prevent loss of the memo stored in the memo insertion hole.

20. The padlock of claim 19, wherein the padlock body is further provided with a container inserted into the memo insertion hole and having a memo mounting hole accommodating the memo.
